(19) United States
(12) Patent Application Publication
(10) Pub. No.: US 2008/0052658 A1
(43) Pub. Date: Feb. 28, 2008

(54) Structure for Dynamically Adjusting Distributed Queuing System and Data Queuing Receiver Reference Voltages

(76) Inventor: Paul Rudrud, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 11/861,622

(22) Filed: Sep. 26, 2007

Related U.S. Application Data
(63) Continuation-in-part of application No. 11/466,779, filed on Aug. 24, 2006.

(51) Int. Cl. G06F 17/50

(52) U.S. Cl. 716/12

(57) ABSTRACT

A design structure embodied in a machine readable medium used in a design process includes an apparatus for automatically setting DQS (Distributed Queuing System) and DQ (Data Queuing) receiver reference voltages, the apparatus including a delay string to measure a number of delay elements that match a DQS high time and a number of delay elements that match a DQS low time; wherein when the number of delay elements for the DQS low time is larger than the number of delay elements for the DQS high time, the reference voltage is decremented until the number of delay elements are equal; and wherein when the number of delay elements for the DQS low time is smaller than the number of delay elements for the DQS high time, the reference voltage is incremented until the number of delay elements are equal.

### CROSS-REFERENCE TO RELATED APPLICATIONS

This non-provisional U.S. patent application is a continuation in part of pending U.S. patent application Ser. No. 11/466,779, which was filed Aug. 24, 2006, and is assigned to the present assignee.

### BACKGROUND OF THE INVENTION

1. Field of the Invention

This invention relates to computer memory, and particularly to a design structure for automatically setting DQS (Distributed Queuing System) and DQ (Data Queuing) receiver reference voltages to an optimal level.

2. Description of background

SDRAM (Synchronous Dynamic Random Access Memory) is a type of DRAM (Dynamic Random Access Memory) memory chip that has been widely used since the latter part of the 1990s. SDRAM chips eliminate wait states because they are fast enough to be synchronized with a CPU's (Central Processing Unit) clock. The SDRAM chip is divided into two cell blocks, and data are interleaved between the cell blocks. While a bit in one block is accessed, a bit in the other is prepared for access. This allows SDRAM to burst subsequent, contiguous characters at a much faster rate than the first character. However, SDRAM has bandwidth limitations. As a result, DDR (Double Data Rate) memory was developed to succeed SDRAM.

DDR refers to an SDRAM memory chip that increases performance by doubling the effective data rate of the front side bus. DDR doubles transfer rates by transferring data on both the rising and falling edges of a CPU clock. DDR uses additional power and ground lines and is packaged on a 184-pin DIMM (Dual In-Line Memory Module) module rather than a 168-pin DIMM used by the first SDRAM chips. However, DDR memory functions at 2.5 V, thus generating a great amount of heat for processors that run at higher frequencies. As a result, DDR2 and DDR3 are being developed to remedy such processor heating issues.

DDR2 chips increase data rates using various techniques such as on-die termination, which places the terminating transistors that eliminate excess signal noise on the chip itself. DDR2 modules require 240-pin DIMM slots, and although they are the same length as DDR, they are keyed differently and do not fit into the DDR slot. DDR2-SDRAM is high-performance main memory. Over its predecessor, DDR-SDRAM, DDR2-SDRAM offers greater bandwidth and density in a smaller package along with a reduction in power consumption. In addition DDR2-SDRAM offers additional features and functions that enable higher clock rate and data rate operations of 400 MHz, 533 MHz, 667 MHz, and above. DDR2 transfers 64 bits of data twice every clock cycle.

DDR3 is being developed, which is the name of an upgraded DDR standard being developed as the successor to DDR2. DDR3 comes with a promise of a power consumption reduction of 40% compared to current commercial DDR2 modules, thus allowing for lower operating currents and voltages.

DDR2 and DDR3 memories used on video cards have different characteristics than the DDR2 and DDR3 memories used on personal computers (PCs), and are referred to as GDDR3. GDDR3 (Graphics Double Data Rate, version 3) is a graphics card-specific memory technology. GDDR3 has much the same technological base as DDR2, but the power and heat dispersal requirements have been reduced, thus allowing for higher-speed memory modules, and simplified cooling systems. GDDR3 memory uses internal terminators, enabling it to better handle certain graphics demands. To improve bandwidth, GDDR3 memory transfers 4 bits of data per pin in 2 clock cycles.

DDR2 and DDR3 memory systems typically use a DQS (Distributed Queuing System) (clock) signal driven coincident with the DQ (Data Queuing) (data) for data returning from the DRAM to the controller. A typical design delays the DQS clock signal by a half of a bit time and uses this delayed DQS signal to clock the data in the first stage of the control chip. There are difficulties in generating the half bit time delay and in generating edge aligned DQ and DQS on DRAMs. These difficulties lead to timing problems centering DQS (clock) in the DQ (data) window.

Considering the limitations of the aforementioned methods, it is clear that there is a need for an efficient method for automatically setting DQS and DQ receiver reference voltages to an optimal level to improve the timing bottleneck.

### SUMMARY OF THE INVENTION

The shortcomings of the prior art are overcome and additional advantages are provided through, in an exemplary embodiment, a design structure embodied in a machine readable medium used in a design process, the design structure including an apparatus for automatically setting DQS (Distributed Queuing System) and DQ (Data Queuing) receiver reference voltages, the apparatus including a delay string to measure a number of delay elements that match a DQS high time and a number of delay elements that match a DQS low time; wherein when the number of delay elements for the DQS low time is larger than the number of delay elements for the DQS high time, the reference voltage is decremented until the number of delay elements are equal; and wherein when the number of delay elements for the DQS low time is smaller than the number of delay elements for the DQS high time, the reference voltage is incremented until the number of delay elements are equal.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for an efficient method for automatically setting DQS and DQ receiver reference voltages to an optimal level.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a graph showing how a system with a reference voltage based on DQS high and low times being equal improves the setup and hold timing margins, where Vref levels are set for equal high and low DQS times (Mismatched up/down drivers), according to the exemplary embodiments of the present invention;

FIG. 2 illustrates one example of a graph showing how a system with a reference voltage based on DQS high and low times being equal improves the setup and hold timing margins, where Vref levels are set for equal high and low DQS times (Nominal Drivers), according to the exemplary embodiments of the present invention;

FIG. 3 illustrates one example of a graph showing how a system with a reference voltage based on DQS high and low times being equal improves the setup and hold timing margins, where Vref levels are set for equal high and low DQS times (Weak Drivers), according to the exemplary embodiments of the present invention;

FIG. 4 illustrates one example of a graph showing how a system with a reference voltage based on DQS high and low times being equal improves the setup and hold timing margins, where Vref levels are set for equal high and low DQS times (Strong Drivers), according to the exemplary embodiments of the present invention;

FIG. 5 illustrates one example of a circuit for implementing the dynamic reference voltage adjustment;

FIG. 6 illustrates one example of a flowchart describing a process for implementing the dynamic reference voltage adjustment; and

FIG. 7 is a flow diagram of an exemplary design process used in semiconductor design, manufacturing, and/or test.

### DETAILED DESCRIPTION OF THE INVENTION

GDDR3 (Graphics Double Data Rate, version 3) DRAM (Dynamic Random Access Memory) data (and DQS) nets are typically terminated to the voltage VDD. Most designers set their receiver reference voltages based on what they think the typical drive strength of the DRAMs is. The problem is that when DRAMs with higher impedance drivers are used, the reference voltage is set to low. Also if the DRAMs have a lower than expected driver impedance, the fixed reference voltage is not set low enough.

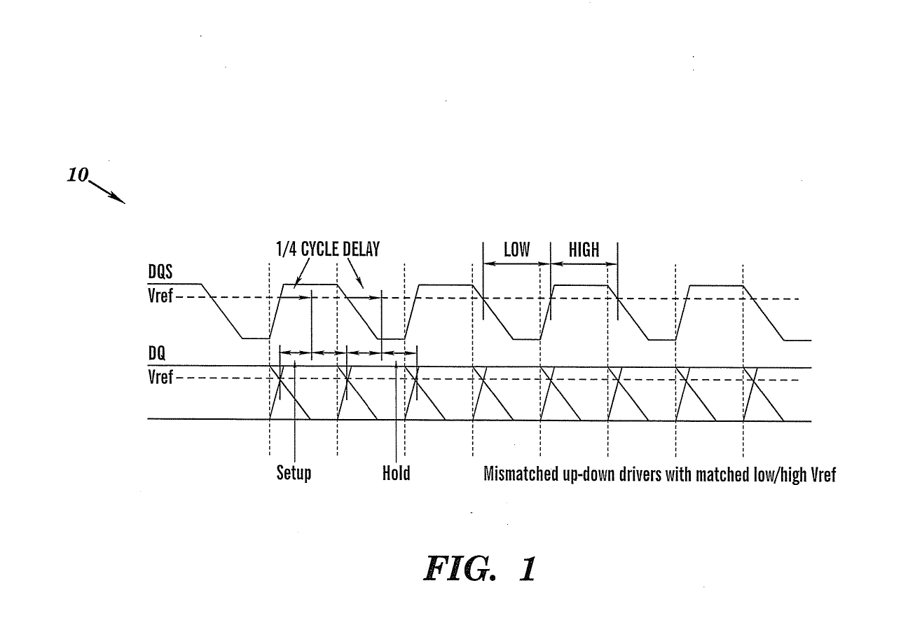

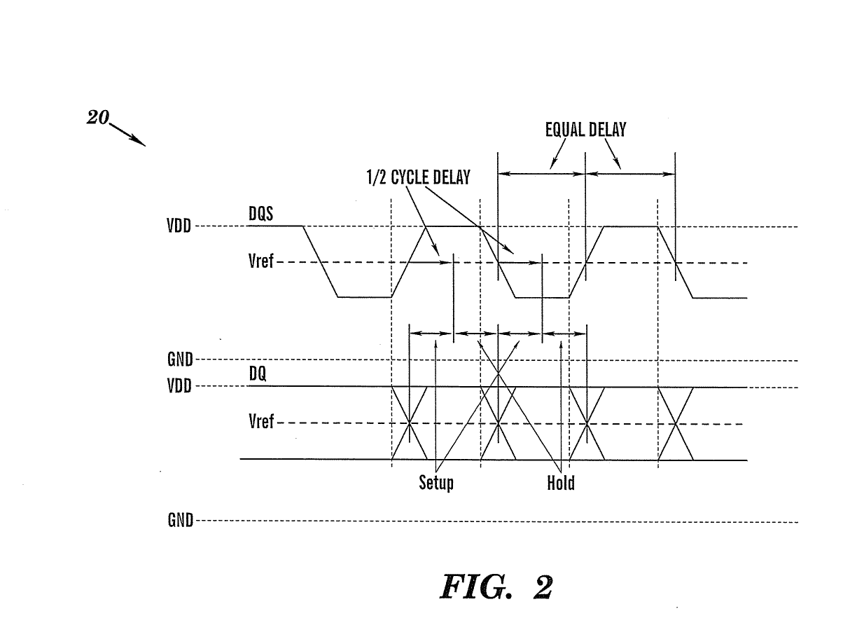

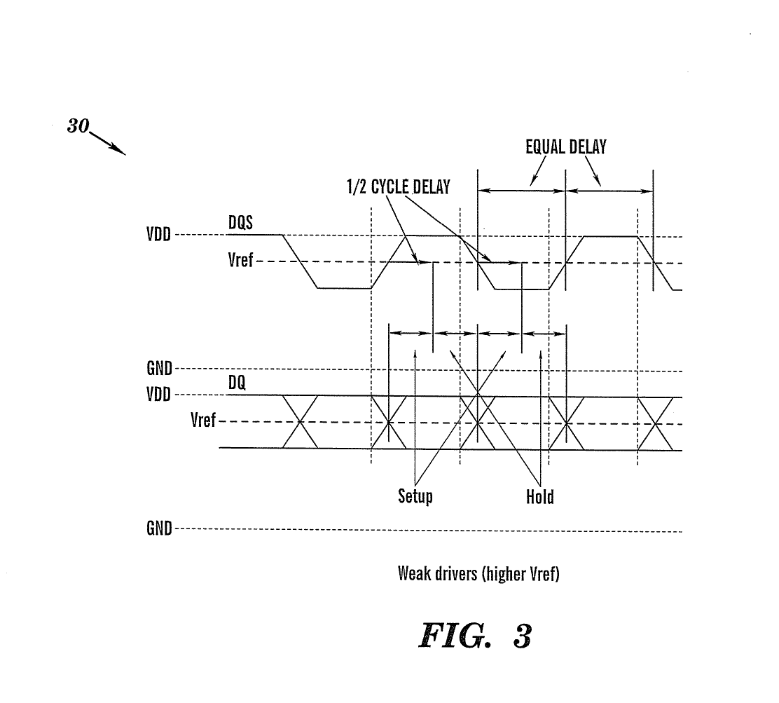

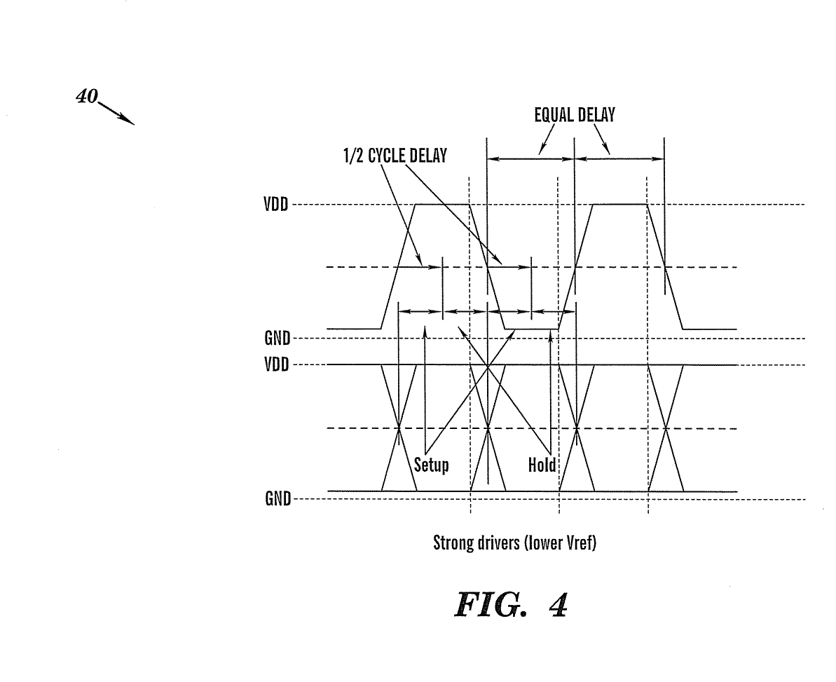

Referring to FIGS. 1-4, examples of how a system with a reference voltage based on DQS high and low times being equal improves the setup and hold timing margins, where Vref levels are set for equal high and low DQS times (Mismatched up/down, Nominal, Weak, Strong Drivers), according to the exemplary embodiments of the present invention are illustrated. FIG. 1 illustrates a graph 10 of a mismatched up/down driver in a passing setup and hold margin. FIG. 2 illustrates a graph 20 of a nominal driver in a passing setup and hold margin. FIG. 3 illustrates a graph 30 of a weak driver in a passing setup and hold margin. FIG. 4 illustrates a graph 40 of a strong driver in a passing setup and hold margin. It will be noted that that FIG. 1 refers to a DDR2 system and that FIGS. 2-4 refer to a DDR3 system.

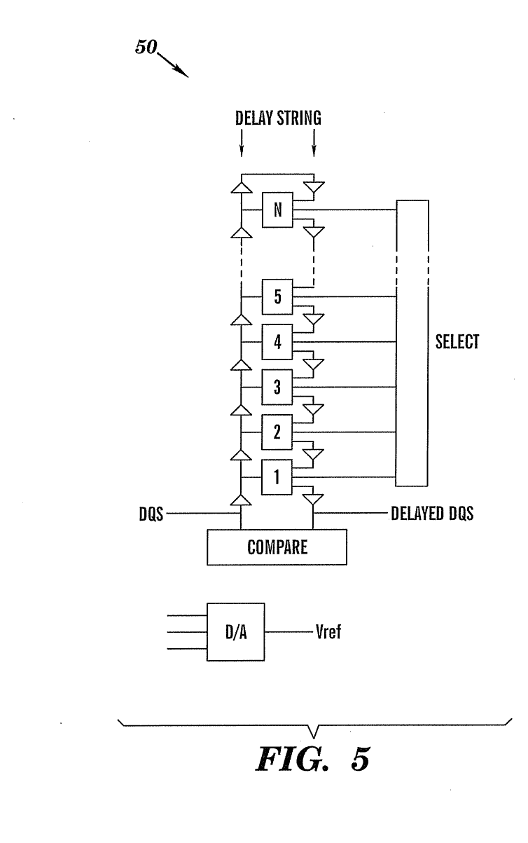

There are many ways to implement this circuit. One way would be to use a delay string to measure how many delay elements are required to match the DQS high time and how many delay elements are required to match the DQS low time. FIG. 5 illustrates one example of a circuit 50 for implementing the dynamic reference voltage adjustment by using a delay string. If the number of delay elements for the DQS low time is larger (or smaller) than the number of elements for the high time, the Vref is set to high (or low) so increment the reference voltage down (or up) until the delay string measurements are equal. This circuit could be continually updating the reference voltage, set during a power on sequence, or set during a periodic training sequence.

In addition, each DRAM drives its own DQS signal and each DRAM has driver impedance that might not match the other DRAMS in the system. An optimal design would have a separate internally generated reference voltage used for each DQS and its associated DQ bits, and each read byte lane would have a separate reference voltage. Although not as useful, reading DDR2 memory that is terminated to VDD/2 can benefit from this method. When reading data from a DDR2 DRAM, the DQ and DQS are driven at the same time and the drivers are assumed to track.

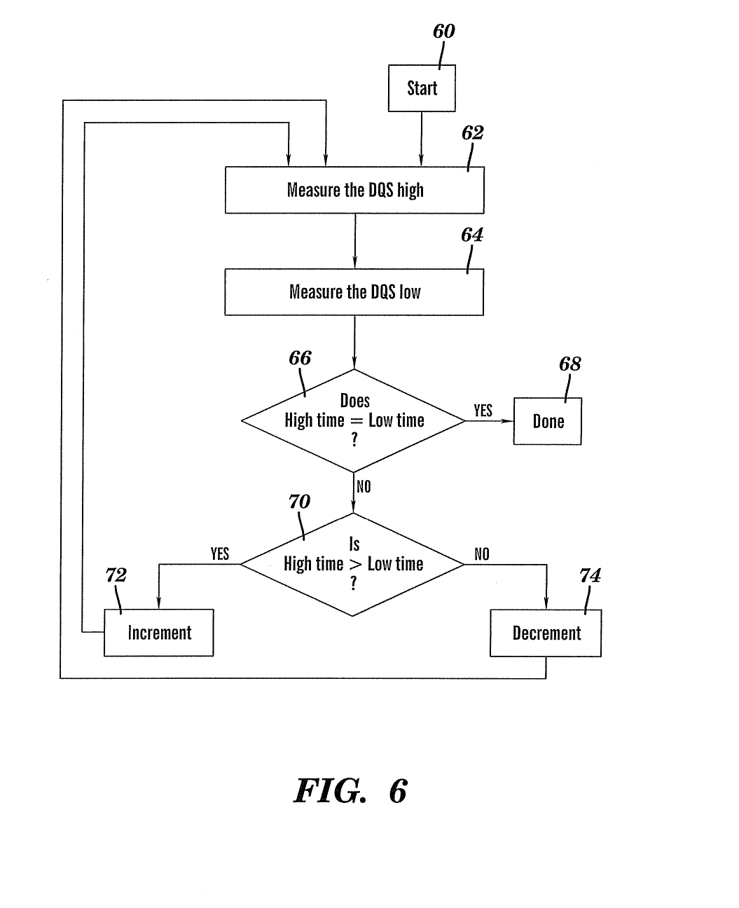

FIG. 6 illustrates one example of a flowchart describing a process for implementing the dynamic reference voltage adjustment. At step 60 the voltage adjustment process commences. At step 62, the DQS High is measured. At step 64, the DQS Low is measured. At step 66, it is determined whether the DQS High time is equal to the DQS Low time. If the DQS High time is equal to the DQS Low time, then the process flows to step 68 where the process is complete. If the DQS High time is not equal to the DQS Low time, then the process flows to step 70. At step 70 it is determined whether the DQS High time is greater than the DQS Low time. If the DQS High time is greater than the DQS Low time, then the process flows to step 72 where the reference voltage is incremented. If the DQS High time is less than the DQS Low time, then the process flows to step 74 where the reference voltage is decremented.

Referring back to FIGS. 2-4, the Vref voltage is adjusted so that the DQS High time is equal to the DQS Low time. Therefore, the Vref is moved up and down until it is evenly splits the graphs 20, 30, and 40.

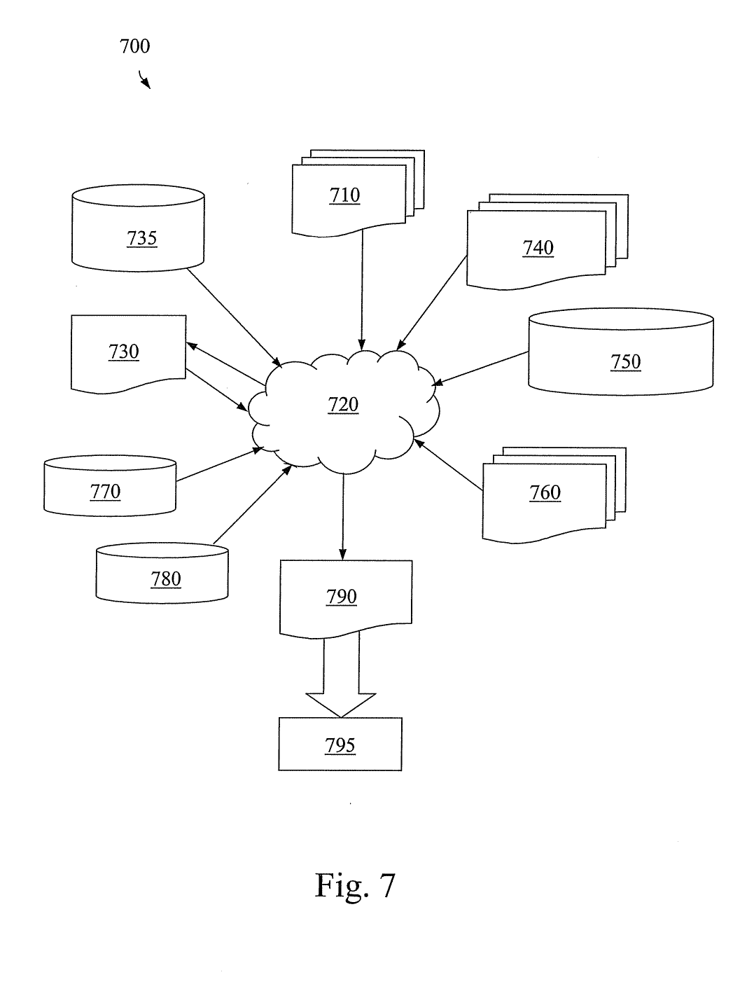

FIG. 7 is a block diagram illustrating an example of a design flow 700. Design flow 700 may vary depending on the type of IC being designed. For example, a design flow 700 for building an application specific IC (ASIC) will differ from a design flow 700 for designing a standard component. Design structure 710 is preferably an input to a design process 720 and may come from an IP provider, a core developer, or other design company or may be generated by the operator of the design flow, or from other sources. Design structure 710 comprises circuit embodiment 50 in the form of schematics or HDL, a hardware-description language, (e.g., Verilog, VHDL, C, etc.). Design structure 710 may be contained on one or more machine readable medium(s). For example, design structure 710 may be a text file or a graphical representation of circuit embodiment 50. Design process 720 synthesizes (or translates) circuit embodiment 50 into a netlist 730, where netlist 730 is, for example, a list of wires, transistors, logic gates, control circuits, I/O, models, etc., and describes the connections to other elements and circuits in an integrated circuit design and recorded on at least one of machine readable medium 715. This may be an iterative process in which netlist 730 is resynthesized one or more times depending on design specifications and parameters for the circuit.

Design process 720 includes using a variety of inputs; for example, inputs from library elements 735 which may house a set of commonly used elements, circuits, and devices, including models, layouts, and symbolic representations, for a given manufacturing technology (e.g., different technology nodes, 32 nm, 45 nm, 90 nm, etc.), design specifications 740, characterization data 750, verification data 760, design rules 770, and test data files 780, which may include test patterns and other testing information. Design process 720 further includes, for example, standard circuit design processes such as timing analysis, verification tools, design rule checkers, place and route tools, etc. One of ordinary skill in the art of integrated circuit design can appreciate the extent of possible electronic design automation tools and applications used in design process 720 without deviating from the scope and spirit of the invention. The design structure of the invention embodiments is not limited to any specific design flow.

Design process 710 preferably translates an embodiment of the invention as shown in FIG. 5, along with any additional integrated circuit design or data (if applicable), into a second design structure 790. Second design structure 790 resides on a storage medium in a data format used for the exchange of layout data of integrated circuits (e.g., information stored in a GDSII (GDS2), GL1, OASIS, or any other suitable format for storing such design structures). Second design structure 790 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIG. 5. Second design structure 790 may then proceed to a stage 795 where, for example, second design structure 790: proceeds to tape-out, is released to manufacturing, is released to a mask house, is sent to another design house, is sent back to the customer, etc.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A design structure embodied in a machine readable medium used in a design process, the design structure comprising:
an apparatus for automatically setting DQS (Distributed Queuing System) and DQ (Data Queuing) receiver reference voltages, the apparatus including a delay string to measure a number of delay elements that match a DQS high time and a number of delay elements that match a DQS low time;
wherein when the number of delay elements for the DQS low time is larger than the number of delay elements for the DQS high time, the reference voltage is decremented until the number of delay elements are equal; and
wherein when the number of delay elements for the DQS low time is smaller than the number of delay elements for the DQS high time, the reference voltage is incremented until the number of delay elements are equal.

2. The design structure of claim 1, wherein the reference voltage is updated during a power on sequence.

3. The design structure of claim 1, wherein the reference voltage is updated during a periodic training sequence.

4. The design structure of claim 1, wherein the reference voltage is different for each DQS and associated DQ bits of the DQS.

5. The design structure of claim 1, wherein the design structure comprises a netlist describing the delay string.

6. The design structure of claim 1, wherein the design structure resides on storage medium as a data format used for the exchange of layout data of integrated circuits.

7. The design structure of claim 1, wherein the design structure includes at least one of test data files, characterization data, verification data, programming data, or design specifications.
